(19) United States
(12) Patent Application Publication
(10) Pub. No.: US 2022/0404634 A1
(43) Pub. Date: Dec. 22, 2022

(54) OPTICAL IMAGING SYSTEM

(71) Applicant: SAMSUNG ELECTRO-MECHANICS CO., LTD., Suwon-si (KR)

(72) Inventors: Yong Joo JO, Suwon-si (KR); Hag Chul KIM, Suwon-si (KR)

(73) Assignee: SAMSUNG ELECTRO-MECHANICS CO., LTD., Suwon-si (KR)

(21) Appl. No.: 17/482,702

(22) Filed: Sep. 23, 2021

(30) Foreign Application Priority Data
Jun. 16, 2021 (KR) 10-2021-0078142

(51) Int. Cl. G02B 27/64; G02B 13/00

(52) U.S. Cl. CPC G02B 27/646; G02B 13/002; G02B 9/34

(57) ABSTRACT

An optical imaging system includes a lens unit including at least three lenses; an image sensor that moves along an optical axis direction and receives light that has passed through the lens unit; and a reflective member disposed on an object side of the lens unit and having a reflective surface to change a path of light. The optical imaging system satisfies 0<(SAS/f)/OD<0.15, where SAS is a moving distance of the image sensor along the optical axis direction, f is a total focal length of the lens unit, and OD is an object distance.

### CROSS-REFERENCE TO RELATED APPLICATIONS

This application claims the benefit under 35 USC 119(a) of Korean Patent Application No. 10-2021-00781 42 filed on Jun. 16, 2021 in the Korean Intellectual Property Office, the entire disclosure of which is incorporated herein by reference for all purposes.

### BACKGROUND

### 1. Field

The following description relates to an optical imaging system

### 2. Description of Related Art

A camera has been used in a portable electronic device such as a smartphone, and in accordance with the demand for miniaturization of a portable electronic device, miniaturization of a camera mounted in a portable electronic device has been necessary.

Further, a telephoto camera has been employed in a portable electronic device to obtain a zoom effect in imaging a subject with a narrow field of view.

However, when a plurality of lenses is disposed in a thickness direction of a portable electronic device as in a general camera, a thickness of the portable electronic device may increase as the number of lenses increases, such that it may be difficult to reduce a size of the portable electronic device.

In particular, since a telephoto camera has a relatively long focal length, it may be difficult to apply a telephoto camera to a portable electronic device having a thin thickness.

Also, in a camera having a focus adjustment function and an optical image stabilization function, generally, a lens module including a plurality of lenses may move. In this case, power consumption may increase due to a weight of the lens module.

SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a lens unit including at least three lenses; an image sensor configured to move along an optical axis direction and to receive light that has passed through the lens unit; and a reflective member disposed on an object side of the lens unit and having a reflective surface for changing a path of light, wherein 0<(SAS/f)/OD<0.15, where SAS is a moving distance of the image sensor in the optical axis direction, f is a total focal length of the lens unit, and OD is an object distance.

The lens unit may include a first lens, a second lens and a third lens disposed in order from the object side, and the optical imaging system may satisfy 0.6 mm<AFS_1.0<0.8 mm, where AFS_1.0 is a moving distance of the image sensor along the optical axis direction with respect to an object distance of 1 meter.

The image sensor may be configured to move in a direction perpendicular to the optical axis direction, and the optical imaging system may satisfy 0.4 mm<OISC_1.0<0.5 mm, where OISC_1.0 is a moving distance of the image sensor in the direction perpendicular to the optical axis direction with respect to an amount of shaking of 1.0°.

The first lens may have positive refractive power, the second lens may have negative refractive power, and the third lens may have positive refractive power.

Each of the first lens, the second lens, and the third lens may include a convex object-side surface and a concave image-side surface.

The lens unit may include a first lens, a second lens, a third lens, and a fourth lens disposed in order from the object side, and the optical imaging system may satisfy 0.15 mm<AFS_1.0<0.25 mm, where AFS_1.0 is a moving distance of the image sensor along the optical axis direction with respect to an object distance of 1 meter.

The image sensor may be configured to move in a direction perpendicular to the optical axis direction, and the optical imaging system may satisfy 0.2 mm<OISC_1.0<0.3 mm, where OISC_1.0 is a moving distance of the image sensor in the direction perpendicular to the optical axis direction with respect to an amount of shaking of 1.0°.

The image sensor may be configured to move in a direction perpendicular to the optical axis direction, and the optical imaging system may satisfy 0.15 mm<OISC_1.0<0.25 mm, where OISC_1.0 is a moving distance of the image sensor in the direction perpendicular to the optical axis direction with respect to an amount of shaking of 1.0°.

The first lens may have positive refractive power, the second lens may have negative refractive power, the third lens may have positive refractive power, and the fourth lens may have positive refractive power.

The first lens may include a convex object-side surface and a convex image-side surface, and the fourth lens may include a convex object-side surface and a concave image-side surface.

The second lens may include a concave object-side surface and a concave image-side surface, and the third lens may include a convex object-side surface and a concave image-side surface.

The second lens may include a convex object-side surface and a concave image-side surface, and the third lens may include a convex object-side surface and a convex image-side surface.

The lens unit may include a first lens, a second lens, a third lens, a fourth lens, and a fifth lens disposed in order from the object side, and the optical imaging system may satisfy 0.4 mm<AFS_1.0<0.6 mm, where AFS_1.0 is a moving distance of the image sensor in the optical axis direction with respect to an object distance of 1 meter.

The image sensor may be configured to move in a direction perpendicular to the optical axis direction, and the optical imaging system may satisfy 0.3 mm<OISC_1.0<0.4 mm, where OISC_1.0 is a moving distance of the image sensor in the direction perpendicular to the optical axis direction with respect to an amount of shaking of 1.0° .

The first lens may have positive refractive power, the second lens may have negative refractive power, the third lens may have positive refractive power, the fourth lens may have negative refractive power, and the fifth lens may have positive refractive power.

The first lens may include a convex object-side surface and a convex image-side surface, the second lens may include a concave object-side surface and a concave image-side surface, and each of the third, fourth, and fifth lenses may include a convex object-side surface and a concave image-side surface.

The optical imaging system may satisfy 0.4<f1/|f_rest|<1, where f1 is a focal length of a lens disposed most adjacent to the object side, and f_rest is a combined focal length of the lenses in the lens unit other than the lens disposed most adjacent to the object side.

In another general aspect, an optical imaging system includes a lens unit including at least three lenses and no more than five lenses; and an image sensor disposed on an image side of the lens unit and configured to move along an optical axis direction and in a direction perpendicular to the optical axis direction, wherein 0<(SAS/f)/OD<0.15, where SAS is a moving distance of the image sensor along the optical axis direction, f is a total focal length of the lens unit, and OD is an object distance, and wherein 0.15 mm<OISC_1.0<0.5 mm, where OISC_1.0 is a moving distance of the image sensor in the direction perpendicular to the optical axis direction with respect to an amount of shaking of 1.0°.

The optical imaging system may include a reflective member disposed on an object side of the lens unit.

The optical imaging system may satisfy 0.8<TTL/f<1, where TTL is an optical-axis distance from an object-side surface of a lens disposed closest to an object side of the lens unit to an imaging plane.

Other features and aspects will be apparent from the following detailed description, the drawings, and the claims.

### BRIEF DESCRIPTION OF DRAWINGS

FIG. 1 is a diagram illustrating an optical imaging system according to a first example.

FIG. 2 is aberration curves of the optical imaging system illustrated in FIG. 1.

FIG. 3 is a diagram illustrating an optical imaging system according to a second example.

FIG. 4 is aberration curves of the optical imaging system illustrated in FIG. 3.

FIG. 5 is a diagram illustrating an optical imaging system according to a third example.

FIG. 6 is aberration curves of the optical imaging system illustrated in FIG. 5.

FIG. 7 is a diagram illustrating an optical imaging system according to a fourth example.

FIG. 8 is aberration curves of the optical imaging system illustrated in FIG. 7.

FIG. 9 is a diagram illustrating an optical imaging system according to a fifth example.

FIG. 10 is aberration curves of the optical imaging system illustrated in FIG. 9.

Throughout the drawings and the detailed description, the same reference numerals refer to the same elements. The drawings may not be to scale, and the relative size, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed, as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is to be noted that use of the term “may” with respect to an embodiment or example, e.g., as to what an embodiment or example may include or implement, means that at least one embodiment or example exists in which such a feature is included or implemented while all examples and examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape occurring during manufacturing.

The features of the examples described herein may be combined in various manners as will be apparent after gaining an understanding of the disclosure of this application. Further, although the examples described herein have a variety of configurations, other configurations are possible as will be apparent after gaining an understanding of the disclosure of this application.

The drawings may not be to scale, and the relative sizes, proportions, and depictions of elements in the drawings may be exaggerated for clarity, illustration, and convenience.

Hereinafter, examples of the present disclosure will be described as follows with respect to the accompanying drawings.

In the lens diagrams, a thickness, a size, and a shape of the lens are exaggerated, and in particular, the shape of a spherical or aspherical surface presented in the lens diagram is merely an example and is not limited thereto.

An optical imaging system according to the various examples may include a lens unit, and the lens unit may include a plurality of lenses disposed along an optical axis. The plurality of lenses may be spaced apart from each other by a predetermined distance along the optical axis. The plurality of lenses may include at least three lenses.

For example, the optical imaging system may include three or more lenses.

In the various examples, an optical imaging system having three, four or five lenses is described, but is the various examples are not limited thereto. For example, the optical imaging system may include six or more lenses.

The forwardmost lens may refer to a lens most adjacent to an object-side surface (or a reflective member), and the rearmost lens may refer to a lens most adjacent to the image sensor.

Also, in each lens, the first surface may refer to a surface adjacent to an object side (or may refer to an object-side surface), and the second surface may refer to a surface adjacent to an image side (or may refer to an image-side surface). Also, in the various examples, a radius of curvature, a thickness, and the like of the lens are indicated in millimeters (mm), and an angle is indicated in degrees.

In the description of the shape of each lens, the configuration in which one surface is convex indicates that a paraxial region portion of the surface is convex, and the configuration in which one surface is concave indicates that a paraxial region portion of the surface is concave.

The paraxial region may refer to a narrow region adjacent to the optical axis.

The imaging plane may refer to a virtual plane on which a focus is formed by the optical imaging system. Alternatively, the imaging surface may refer to one surface of the image sensor on which light is received.

The optical imaging system in the various examples may include at least three lenses.

For example, the optical imaging system may include a first lens, a second lens, and a third lens arranged in order from an object side. The first lens may be a forwardmost lens, and a third lens may be a rearmost lens.

Alternatively, the optical imaging system may include a first lens, a second lens, a third lens, and a fourth lens arranged in order from an object side. The first lens may be a forwardmost lens, and a fourth lens may be a rearmost lens.

Alternatively, the optical imaging system may include a first lens, a second lens, a third lens, a fourth lens, and a fifth lens arranged in order from an object side. The first lens may be a forwardmost lens, and the fifth lens may be a rearmost lens.

The optical imaging system in the various examples may further include components other than the lenses.

For example, the optical imaging system may further include a reflective member having a reflective surface for changing a path of light. For example, the reflective member may be implemented as a mirror or a prism.

The reflective member may be disposed more adjacent to the object side than the plurality of lenses. For example, the reflective member may be disposed in front of the first lens (more adjacent to the object side than the first lens). Accordingly, the lens disposed most adjacent to the object side may be disposed most adjacent to the reflection member.

The optical imaging system may further include an image sensor for converting an incident image of a subject into an electrical signal.

The optical imaging system may further include an infrared cut-off filter (hereinafter, referred to as a filter) for blocking infrared rays. The filter may be disposed between the lens disposed most adjacent to the image sensor (rearmost lens) and the image sensor.

The overall lenses included in the optical imaging system in the various examples may be formed of a plastic material.

In the optical imaging system in the various examples, a refractive index of the second lens may be greater than that of the first lens. Also, an average refractive index of the lenses other than the first lens may be configured to be greater than the refractive index of the first lens.

The optical imaging system in the various examples may be configured such that the image sensor may move to adjust a focus or to correct shaking of an image. For example, the image sensor of the optical imaging system in the various examples may move in the optical axis direction and/or in a direction perpendicular to the optical axis.

In other words, the image sensor may move in the optical axis direction to focus on a subject.

Also, when shaking occurs during imaging due to user hand-shake, or the like, the shaking may be corrected by applying a relative displacement corresponding to the shaking to the image sensor.

Although not illustrated in the drawings, a driving unit may be provided to move the image sensor, and the driving unit may include a VCM actuator using a magnet and a coil.

The optical imaging system in the various examples may have the characteristics of a telephoto lens having a relatively narrow field of view and a long focal length.

Each of the plurality of lenses may have at least one aspherical surface.

In other words, at least one of the first surface and the second surface of each lens may be an aspherical surface. The aspherical surface of each lens may be represented by Equation

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} … \qquad [ Equation 1 ]$$

In Equation 1, c is a curvature of the lens (a reciprocal of the radius of curvature), K is a conic constant, and Y is a distance from one point on the aspherical surface of the lens to the optical axis. Also, constants A to J are aspheric coefficients. Z is a distance (SAG) from one point on the aspherical surface of the lens to a vertex of the aspherical surface.

The optical imaging system in the various examples may satisfy conditional expression 1 as below:

Conditional Expression 1: 0<(SAS/f)/OD<0.15

Also, the optical imaging system in the various examples may satisfy at least one of the conditional expressions as below:

Conditional Expression 2: 0<L1S1/f<0.3

Conditional Expression 3: −2<(L1S1+L1S2)/(L1S1−L1S2)<0

Conditional Expression 4: 0<L2S2/f<0.3

Conditional Expression 5: 0.5<(L2S1+L2S2)/(L2S1−L2S2)<2

Conditional Expression 6: 2<f/f1<3.5

Conditional Expression 7: −4.5<f/f2<−2

Conditional Expression 8: 0.5<BFL/TTL<0.8

Conditional Expression 9: 2.2<TTL/(2*IMG HT)<5

Conditional Expression 10: 0.8<TTL/f<1

Conditional Expression 11: 0.4<f1/|f_rest|<1

Conditional Expression 12: 1.6<n_avg<1.7

In the conditional expressions, SAS is a moving distance of the image sensor in the optical axis direction, f is a total focal length of the optical imaging system, and OD is an object distance.

In the conditional expressions, L1S1 is a radius of curvature of the object-side surface of the first lens, L1S2 is a radius of curvature of the image-side surface of the first lens, L2S1 is a radius of curvature of the object-side surface of the second lens, and L2S2 is a radius of curvature of an image-side surface of the second lens.

In the conditional expressions, f1 is a focal length of the first lens, f2 is a focal length of the second lens, and f_rest is a combined focal length of the lenses other than the first lens.

In the conditional expressions, BFL is an optical-axis distance from the image-side surface of the rearmost lens to the imaging plane, TTL is an optical-axis distance from the object-side surface of the forwardmost lens to the imaging plane, and IMG HT is a half the diagonal length of the imaging plane.

In the conditional expressions, n_avg is an average value of refractive indices of the lenses other than the first lens.

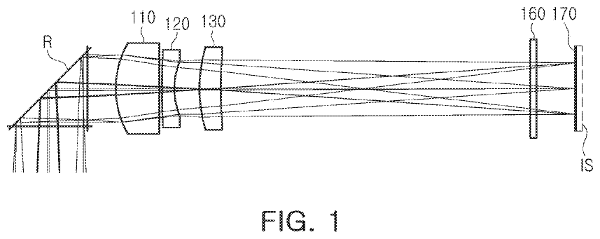

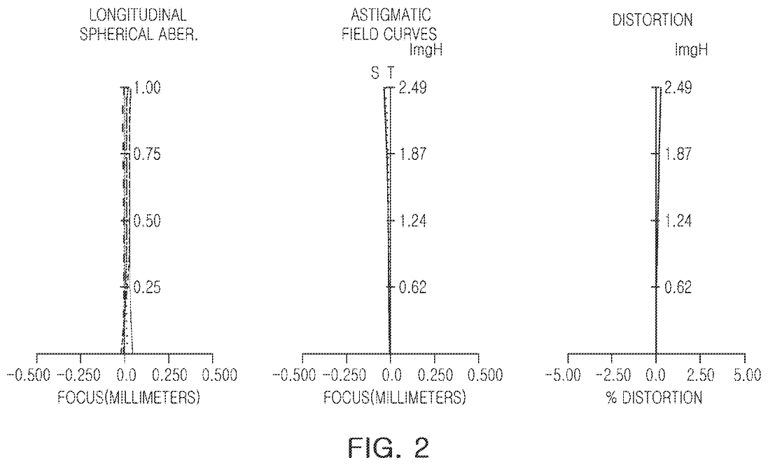

An optical imaging system according to a first example will be described with reference to FIGS. 1 and 2.

The optical imaging system in the first example may include an optical system including a first lens 110, a second lens 120, and a third lens 130, and may further include a filter 160 and an image sensor IS.

Also, the optical imaging system may further include a reflective member R disposed in front of the first lens 110 and having a reflective surface for changing a path of light. In the first example, the reflective member R may be implemented as a prism, but may also be implemented as a mirror.

The optical imaging system in the first example may form a focus on the imaging surface 170. The imaging surface 170 may refer to a surface on which a focus is formed by the optical imaging system. For example, the imaging surface 170 may refer to one surface of the image sensor IS on which light is received.

Lens properties of each lens (a radius of curvature, a thickness of the lens or a distance between lenses, a refractive index, an Abbe number, and a focal length) may be as provided in Table 1.

TABLE 1

| Surface | | Radius of | Thickness | Refractive | Abbe | Focal |
|---|---|---|---|---|---|---|
| No. | Note | curvature | or distance | index | number | length |
| S1 | Reflective | Infinity | 2.500 | 1.717 | 29.5 | |
| | member | | | | | |
| S2 | | Infinity | 2.500 | 1.717 | 29.5 | |
| S3 | | Infinity | 2.000 | | | |
| S4 | First lens | 4.978 | 2.308 | 1.535 | 56 | 9.449 |
| S5 | | 115.305 | 0.150 | | | |
| S6 | Second lens | 23.763 | 0.674 | 1.615 | 25.9 | −7.558 |
| S7 | | 3.875 | 1.341 | | | |
| S8 | Third lens | 9.270 | 1.121 | 1.671 | 19.2 | 22.388 |
| S9 | | 22.569 | 16.469 | | | |
| S10 | Filter | Infinity | 0.300 | 1.516 | 64.1 | |
| S11 | | Infinity | 2.095 | | | |
| S12 | Imaging | Infinity | | | | |
| | plane | | | | | |

The total focal length f of the optical imaging system in the first example may be 26 mm, F number (hereinafter, referred to as “Fno”) of the optical imaging system may be 4.3, a half the diagonal length of the imaging plane 170 may be 2.49 mm, and a combined focal length of the second lens 120 and the third lens 130 may be −12.143 mm.

In the first example, the first lens 110 may have positive refractive power, a first surface of the first lens 110 may be convex, and a second surface of the first lens 110 may be concave.

The second lens 120 may have negative refractive power, a first surface of the second lens 120 may be convex, and a second surface of the second lens 120 may be concave.

The third lens 130 may have positive refractive power, the first surface of the third lens 130 may be convex, and the second surface of the third lens 130 may be concave.

The optical imaging system in the first example may be configured such that the image sensor IS may move for focus adjustment. For example, the image sensor IS of the optical imaging system in the first example may move in the optical axis direction.

Table 2 lists a moving distance AFS of the image sensor IS in the optical axis direction according to the object distance OD in the optical imaging system in the first example.

TABLE 2

| Object | Moving distance of imaging sensor in |
|---|---|
| distance | optical axis direction |
| 2.0M | 0.3431 mm |
| 1.5M | 0.4599 mm |
| 1.0M | 0.6969 mm |
| 0.5M | 1.438 mm |

The optical imaging system in the first example may satisfy the conditional expression as below:

Conditional Expression 13: 0.6 mm<AFS_1.0<0.8 mm

In the conditional expression, AFS_1.0 is a moving distance of the image sensor IS in the optical axis direction with respect to an object distance OD of 1.0 meter.

The optical imaging system in the first example may be configured such that the image sensor IS may move for optical image stabilization. For example, the image sensor IS of the optical imaging system in the first example may move in a direction perpendicular to the optical axis.

Table 3 lists the moving distance of the image sensor IS in the direction perpendicular to the optical axis according to the amount of shaking in the optical imaging system in the first example. The amount of shaking may be measured by a shaking detection unit (e.g., a gyro sensor).

TABLE 3

| Amount of | Moving distance of imaging sensor in direction |
|---|---|
| shaking | perpendicular to optical axis |
| 0.5 deg | 0.226 mm |
| 1.0 deg | 0.453 mm |
| 1.5 deg | 0.680 mm |
| 2.0 deg | 0.907 mm |

The optical imaging system in the first example may satisfy the conditional expression as below:

Conditional Expression 14: 0.4 mm<OISC_1.0<0.5 mm

In the conditional expression, OISC_1.0 is a moving distance of the image sensor IS in the direction perpendicular to the optical axis with respect to the amount of shaking of 1.0°.

Since the optical imaging system in the first example may perform focus adjustment and optical image stabilization by moving the image sensor IS, power consumption may be reduced.

Each surface of the first lens 110 to the third lens 130 may have an aspherical coefficient as provided in Table 4. For example, the object-side surfaces and the image-side surfaces of the first lens 110 to the third lens 130 may be aspherical.

TABLE 4

| | S4 | S5 | S6 | S7 | S8 | S9 |
|---|---|---|---|---|---|---|
| conic | 0.108586173 | −99 | 44.28062425 | 0.325078127 | −0.35515807 | 19.64907497 |
| constant(K) | | | | | | |
| 4th | −1.751E−04 | −5.496E−03 | −1.286E−02 | −1.084E−02 | −9.784E−04 | −2.156E−04 |
| coefficient | | | | | | |
| (A) | | | | | | |
| 6th | 1.202E−04 | 1.107E−02 | 1.377E−02 | 4.395E−03 | 1.784E−05 | −1.174E−05 |
| coefficient | | | | | | |
| (B) | | | | | | |
| 8th | −4.339E−05 | −8.674E−03 | −1.028E−02 | −2.562E−03 | 8.828E−05 | −7.900E−06 |
| coefficient | | | | | | |
| (C) | | | | | | |
| 10th | 5.345E−07 | 3.930E−03 | 4.838E−03 | 1.336E−03 | −8.287E−06 | 3.946E−05 |
| coefficient | | | | | | |
| (D) | | | | | | |
| 12th | 3.222E−06 | −1.100E−03 | −1.421E−03 | −4.407E−04 | 4.238E−06 | −1.553E−05 |
| coefficient | | | | | | |
| (E) | | | | | | |
| 14th | −9.608E−07 | 1.914E−04 | 2.599E−04 | 9.066E−05 | 3.061E−07 | 5.783E−06 |
| coefficient | | | | | | |
| (F) | | | | | | |
| 16th | 1.293E−07 | −2.005E−05 | −2.867E−05 | −1.157E−05 | −7.951E−07 | −1.820E−06 |
| coefficient | | | | | | |
| (G) | | | | | | |
| 18th | −8.500E−09 | 1.153E−06 | 1.741E−06 | 8.345E−07 | 1.633E−07 | 2.877E−07 |
| coefficient | | | | | | |
| (H) | | | | | | |
| 20th | 2.207E−10 | −2.790E−08 | −4.461E−08 | −2.545E−08 | −9.826E−09 | −1.677E−08 |
| coefficient | | | | | | |
| (J) | | | | | | |

Also, the optical imaging system configured as above may have the aberration properties as in FIG. 2.

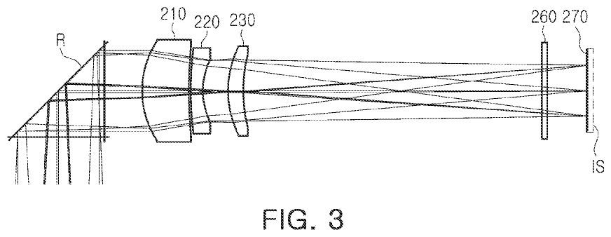

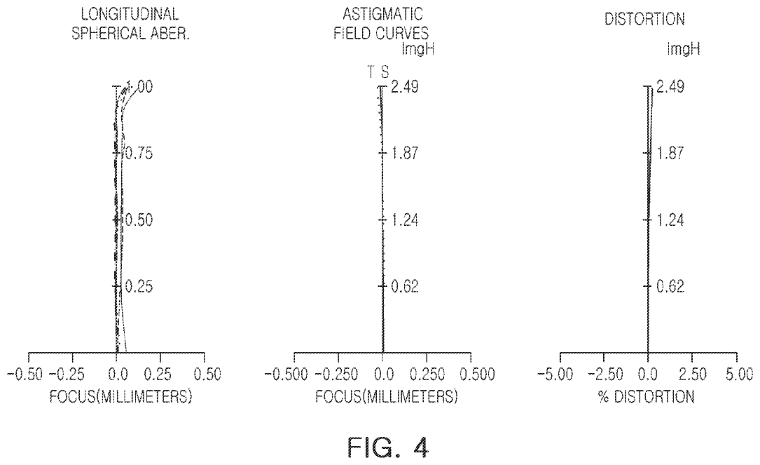

An optical imaging system according to a second example will be described with reference to FIGS. 3 and 4.

The optical imaging system in the second example may include an optical system including a first lens 210, a second lens 220, and a third lens 230, and may further include a filter 260 and an image sensor IS.

Also, the optical imaging system may further include a reflective member R disposed in front of the first lens 210 and having a reflective surface for changing a path of light. In the second example, the reflective member R may be implemented as a prism, but may also be implemented as a mirror.

The optical imaging system in the second example may form a focus on the imaging surface 270. The imaging surface 270 may refer to a surface on which a focus is formed by the optical imaging system. For example, the imaging surface 270 may refer to one surface of the image sensor IS on which light is received.

Lens properties of each lens (a radius of curvature, a thickness of the lens or a distance between lenses, a refractive index, an Abbe number, and a focal length) may be as provided in Table 5.

TABLE 5

| Surface | | Radius of | Thickness | Refractive | Abbe | Focal |
|---|---|---|---|---|---|---|
| No. | Note | curvature | or distance | index | number | length |
| S1 | Reflective | Infinity | 2.500 | 1.717 | 29.5 | |
| | member | | | | | |
| S2 | | Infinity | 2.500 | 1.717 | 29.5 | |
| S3 | | Infinity | 2.000 | | | |
| S4 | First lens | 5.055 | 2.550 | 1.583 | 59.4 | 9.517 |
| S5 | | 44.279 | 0.096 | | | |
| S6 | Second lens | 19.256 | 0.620 | 1.615 | 25.9 | −7.330 |
| S7 | | 3.635 | 1.408 | | | |
| S8 | Third lens | 5.762 | 0.799 | 1.671 | 19.2 | 20.798 |
| S9 | | 9.182 | 16.088 | | | |
| S10 | Filter | Infinity | 0.300 | 1.516 | 64.1 | |
| S11 | | Infinity | 2.089 | | | |
| S12 | Imaging | Infinity | | | | |
| | plane | | | | | |

The total focal length f of the optical imaging system in the second example may be 26 mm, Fno may be 4.1, a half the diagonal length of the imaging plane 270 may be 2.49 mm, and a combined focal length of the second lens 220 and the third lens 230 may be −11.902 mm.

In the second example, the first lens 210 may have positive refractive power, a first surface of the first lens 210 may be convex, and a second surface of the first lens 210 may be concave.

The second lens 220 may have negative refractive power, a first surface of the second lens 220 may be convex, and a second surface of the second lens 220 may be concave.

The third lens 230 may have positive refractive power, the first surface of the third lens 230 may be convex, and the second surface of the third lens 230 may be concave.

The optical imaging system in the second example may be configured such that the image sensor IS may move for focus adjustment. For example, the image sensor IS of the optical imaging system in the second example may move in the optical axis direction.

Table 6 lists a moving distance AFS of the image sensor IS in the optical axis direction according to the object distance OD in the optical imaging system in the second example.

TABLE 6

| Object | Moving distance of imaging sensor in |
|---|---|
| distance | optical axis direction |
| 2.0M | 0.3431 mm |
| 1.5M | 0.4599 mm |
| 1.0M | 0.6969 mm |
| 0.5M | 1.438 mm |

The optical imaging system in the second example may satisfy the conditional expression as below:

Conditional Expression 13: 0.6 mm<AFS_1.0<0.8 mm

In the conditional expression, AFS_1.0 is a moving distance of the image sensor IS in the optical axis direction with respect to an object distance OD of 1.0 meter.

The optical imaging system in the second example may be configured such that the image sensor IS may move for optical image stabilization. For example, the image sensor IS of the optical imaging system in the second example may move in a direction perpendicular to the optical axis.

Table 7 lists the moving distance of the image sensor IS in the direction perpendicular to the optical axis according to the amount of shaking in the optical imaging system in the second example. The amount of shaking may be measured by a shaking detection unit (e.g., a gyro sensor).

TABLE 7

| Amount of | Moving distance of imaging sensor in direction |
|---|---|
| shaking | perpendicular to optical axis |
| 0.5 deg | 0.226 mm |
| 1.0 deg | 0.453 mm |
| 1.5 deg | 0.680 mm |
| 2.0 deg | 0.907 mm |

The optical imaging system in the second example may satisfy the conditional expression as below:

Conditional Expression 14: 0.4 mm<OISC_1.0<0.5mm

In the conditional expression, OISC_1.0 is a moving distance of the image sensor IS in the direction perpendicular to the optical axis with respect to the amount of shaking of 1.0°.

Since the optical imaging system in the second example may perform focus adjustment and optical image stabilization by moving the image sensor IS, power consumption may be reduced.

Each surface of the first lens 210 to the third lens 230 may have an aspherical coefficient as provided in Table 8. For example, the object-side surfaces and the image-side surfaces of the first lens 210 to the third lens 230 may be aspherical.

TABLE 8

| | S4 | S5 | S6 | S7 | S8 | S9 |
|---|---|---|---|---|---|---|
| conic | 0.092974225 | −99 | 38.62148519 | 0.210473924 | −0.67684378 | 8.914952795 |
| constant(K) | | | | | | |
| 4th | −1.992E−04 | −5.690E−03 | −1.439E−02 | −1.244E−02 | −7.820E−04 | −1.043E−03 |
| coefficient | | | | | | |
| (A) | | | | | | |
| 6th | 1.659E−04 | 1.543E−02 | 1.856E−02 | 5.013E−03 | −2.748E−05 | 9.001E−05 |
| coefficient | | | | | | |
| (B) | | | | | | |
| 8th | −1.095E−04 | −1.478E−02 | −1.674E−02 | −3.713E−03 | 2.999E−05 | −2.919E−04 |
| coefficient | | | | | | |
| (C) | | | | | | |
| 10th | 3.505E−05 | 7.971E−03 | 9.267E−03 | 2.672E−03 | 8.982E−05 | 2.462E−04 |
| coefficient | | | | | | |
| (D) | | | | | | |
| 12th | −6.606E−06 | −2.601E−03 | −3.133E−03 | −1.199E−03 | −5.785E−05 | −1.125E−04 |
| coefficient | | | | | | |
| (E) | | | | | | |
| 14th | 6.742E−07 | 5.199E−04 | 6.490E−04 | 3.305E−04 | 2.742E−05 | 4.540E−05 |
| coefficient | | | | | | |
| (F) | | | | | | |
| 16th | −2.810E−08 | −6.199E−05 | −8.025E−05 | −5.548E−05 | −7.851E−06 | −1.289E−05 |
| coefficient | | | | | | |
| (G) | | | | | | |
| 18th | −3.753E−10 | 4.038E−06 | 5.429E−06 | 5.187E−06 | 1.098E−06 | 1.913E−06 |
| coefficient | | | | | | |
| (H) | | | | | | |
| 20th | 4.625E−11 | −1.104E−07 | −1.544E−07 | −2.058E−07 | −5.807E−08 | −1.101E−07 |
| coefficient | | | | | | |
| (J) | | | | | | |

Also, the optical imaging system configured as above may have the aberration properties as in FIG. 4.

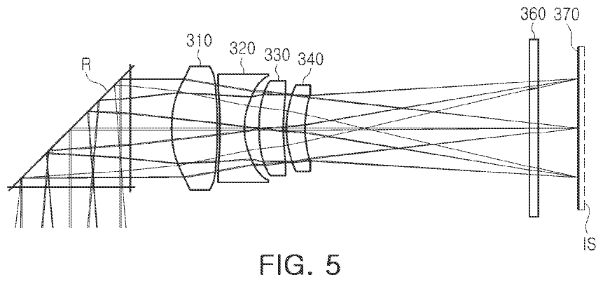

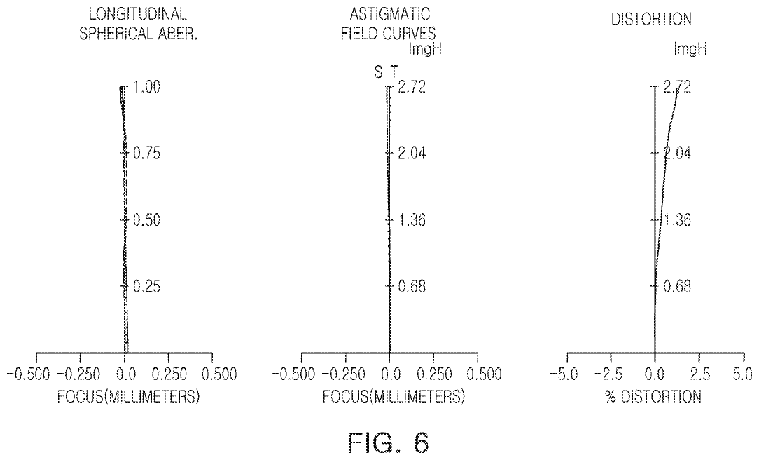

An optical imaging system according to a third example will be described with reference to FIGS. 5 and 6.

The optical imaging system in the third example may include an optical system including a first lens 310, a second lens 320, a third lens 330, and a fourth lens 340 and may further include a filter 360 and an image sensor IS.

Also, the optical imaging system may further include a reflective member R disposed in front of the first lens 310 and having a reflective surface for changing a path of light. In the third example, the reflective member R may be implemented as a prism, but may also be implemented as a mirror.

The optical imaging system in the third example may form a focus on the imaging surface 370. The imaging surface 370 may refer to a surface on which a focus is formed by the optical imaging system. For example, the imaging surface 370 may refer to one surface of the image sensor IS on which light is received.

Lens properties of each lens (a radius of curvature, a thickness of the lens or a distance between lenses, a refractive index, an Abbe number, and a focal length) may be as provided in Table 9.

TABLE 9

| Surface | | Radius of | Thickness | Refractive | Abbe | Focal |
|---|---|---|---|---|---|---|
| No. | Note | curvature | or distance | index | number | length |
| S1 | Reflective | Infinity | 2.500 | 1.717 | 29.5 | |
| | member | | | | | |
| S2 | | Infinity | 2.500 | 1.717 | 29.5 | |
| S3 | | Infinity | 2.000 | | | |
| S4 | First lens | 3.400 | 1.557 | 1.535 | 56 | 5.097 |
| S5 | | −11.836 | 0.089 | | | |
| S6 | Second lens | −25.187 | 0.827 | 1.615 | 25.9 | −3.349 |
| S7 | | 2.294 | 0.497 | | | |
| S8 | Third lens | 6.06265 | 0.811 | 1.671 | 19.2 | 14.048 |
| S9 | | 15.73953 | 0.097 | | | |
| S10 | Fourth lens | 2.43661 | 0.630 | 1.615 | 25.9 | 19.674 |
| S11 | | 2.74271 | 7.586 | | | |
| S12 | Filter | Infinity | 0.300 | 1.516 | 64.1 | |
| S13 | | Infinity | 1.332 | | | |
| S14 | Imaging | Infinity | | | | |
| | plane | | | | | |

The total focal length f of the optical imaging system in the third example may be 14.5 mm, Fno may be 3.9, a half the diagonal length of the imaging plane 370 may be 2.72 mm, and a combined focal length of the second lens 320 to the fourth lens 340 may be −5.672 mm.

In the third example, the first lens 310 may have positive refractive power, and first and second surfaces of the first lens 310 may be convex.

The second lens 320 may have negative refractive power, and first and second surfaces of the second lens 320 may be concave.

The third lens 330 may have positive refractive power, the first surface of the third lens 330 may be convex, and the second surface of the third lens 330 may be concave.

The fourth lens 340 may have positive refractive power, the first surface of the fourth lens 340 may be convex, and the second surface of the fourth lens 340 may be concave.

The optical imaging system in the third example may be configured such that the image sensor IS may move for focus adjustment. For example, the image sensor IS of the optical imaging system in the third example may move in the optical axis direction.

Table 10 lists a moving distance AFS of the image sensor IS in the optical axis direction according to the object distance OD in the optical imaging system in the third example.

TABLE 10

| Object | Moving distance of imaging sensor in |
|---|---|
| distance | optical axis direction |
| 2.0M | 0.1059 mm |
| 1.5M | 0.1415 mm |
| 1.0M | 0.2133 mm |
| 0.5M | 1.4328 mm |

The optical imaging system in the third example may satisfy the conditional expression as below:

Conditional Expression 15: 0.15 mm<AFS_1.0<0.25 mm

In the conditional expression, AFS_1.0 is a moving distance of the image sensor IS in the optical axis direction with respect to an object distance OD of 1.0 meter.

The optical imaging system in the third example may be configured such that the image sensor IS may move for optical image stabilization. For example, the image sensor IS of the optical imaging system in the third example may move in a direction perpendicular to the optical axis.

Table 11 lists the moving distance of the image sensor IS in the direction perpendicular to the optical axis according to the amount of shaking in the optical imaging system in the third example. The amount of shaking may be measured by a shaking detection unit (e.g., a gyro sensor).

TABLE 11

| Amount of | Moving distance of imaging sensor in direction |
|---|---|
| shaking | perpendicular to optical axis |
| 0.5 deg | 0.130 mm |
| 1.0 deg | 0.261 mm |
| 1.5 deg | 0.392 mm |
| 2.0 deg | 0.523 mm |

The optical imaging system in the third example may satisfy the conditional expression as below:

Conditional Expression 16: 0.2<OISC_1.0<0.3

In the conditional expression, OISC_1.0 is a moving distance of the image sensor IS in the direction perpendicular to the optical axis with respect to the amount of shaking of 1.0°.

Since the optical imaging system in the third example may perform focus adjustment and optical image stabilization by moving the image sensor IS, power consumption may be reduced.

Each surface of the first lens 310 to the fourth lens 340 may have an aspherical coefficient as provided in Table 12. For example, the object-side surfaces and the image-side surfaces of the first lens 310 to the fourth lens 340 may be aspherical.

TABLE 12

| | S4 | S5 | S6 | S7 |
|---|---|---|---|---|
| conic | −0.19462401 | 39.47526272 | −53.7247539 | 0.228528713 |
| constant(K) | | | | |
| 4th | 5.636E−04 | 7.482E−03 | −1.844E−02 | −4.081E−02 |
| coefficient | | | | |
| (A) | | | | |
| 6th | −6.645E−04 | −2.307E−03 | 8.223E−03 | 1.549E−02 |
| coefficient | | | | |
| (B) | | | | |
| 8th | 5.055E−04 | 8.451E−04 | −8.890E−04 | −3.313E−03 |
| coefficient | | | | |
| (C) | | | | |
| 10th | −4.856E−04 | 1.913E−04 | −1.097E−05 | 3.697E−04 |
| coefficient | | | | |
| (D) | | | | |
| 12th | 2.142E−04 | 3.612E−06 | 5.894E−05 | −4.566E−04 |
| coefficient | | | | |
| (E) | | | | |
| 14th | −4.734E−05 | −5.055E−05 | −2.163E−05 | 3.394E−04 |
| coefficient | | | | |
| (F) | | | | |
| 16th | 3.361E−06 | 5.926E−06 | −6.124E−06 | −1.334E−04 |
| coefficient | | | | |
| (G) | | | | |
| 18th | 3.973E−07 | −1.418E−06 | −7.985E−07 | 2.498E−05 |
| coefficient | | | | |
| (H) | | | | |
| 20th | −6.813E−08 | 6.644E−07 | 7.948E−07 | 1.914E−15 |
| coefficient | | | | |
| (J) | | | | |
| | S8 | S9 | S10 | S11 |
| conic | 12.22551644 | 80.81051093 | −3.41152165 | 0.932324387 |
| constant(K) | | | | |
| 4th | 2.074E−02 | 1.003E−02 | −1.797E−02 | −3.891E−02 |
| coefficient | | | | |
| (A) | | | | |
| 6th | −1.020E−02 | −1.585E−04 | 1.689E−03 | −8.794E−04 |
| coefficient | | | | |
| (B) | | | | |
| 8th | 5.536E−03 | −7.715E−04 | −2.708E−04 | 2.598E−03 |
| coefficient | | | | |
| (C) | | | | |
| 10th | −2.028E−03 | 2.679E−03 | 1.127E−03 | −2.858E−03 |
| coefficient | | | | |
| (D) | | | | |
| 12th | 2.629E−04 | −9.033E−04 | −1.892E−04 | 1.676E−03 |
| coefficient | | | | |
| (E) | | | | |
| 14th | 0.000E+00 | −2.320E−04 | −1.074E−04 | −3.796E−04 |
| coefficient | | | | |
| (F) | | | | |
| 16th | 0.000E+00 | 1.495E−04 | 3.941E−05 | 1.087E−13 |
| coefficient | | | | |
| (G) | | | | |
| 18th | 0.000E+00 | 9.833E−17 | 0.000E+00 | −4.769E−19 |
| coefficient | | | | |
| (H) | | | | |
| 20th | 0.000E+00 | 4.385E−17 | 0.000E+00 | −1.184E−17 |
| coefficient | | | | |
| (J) | | | | |

Also, the optical imaging system configured as above may have the aberration properties as in FIG. 6.

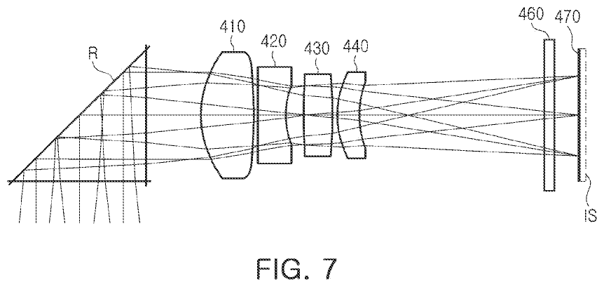

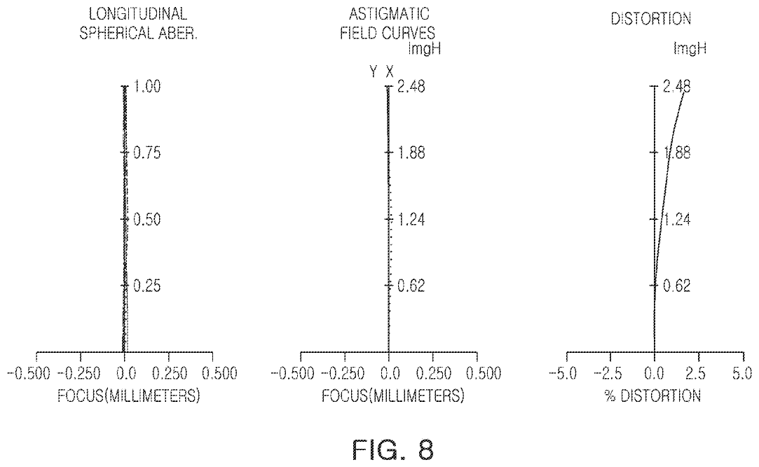

An optical imaging system according to a fourth example will be described with reference to FIGS. 7 and 8.

The optical imaging system in the fourth example may include an optical system including a first lens 410, a second lens 420, a third lens 430, and a fourth lens 440 and may further include a filter 460 and an image sensor IS.

Also, the optical imaging system may further include a reflective member R disposed in front of the first lens 410 and having a reflective surface for changing a path of light. In the fourth example, the reflective member R may be implemented as a prism, but may also be implemented as a mirror.

The optical imaging system in the fourth example may form a focus on the imaging surface 470. The imaging surface 470 may refer to a surface on which a focus is formed by the optical imaging system. For example, the imaging surface 470 may refer to one surface of the image sensor IS on which light is received.

Lens properties of each lens (a radius of curvature, a thickness of the lens or a distance between lenses, a refractive index, an Abbe number, and a focal length) may be as provided in Table 13.

TABLE 13

| Surface | | Radius of | Thickness | Refractive | Abbe | Focal |
|---|---|---|---|---|---|---|
| No. | Note | curvature | or distance | index | number | length |
| S1 | Reflective | Infinity | 2.500 | 1.717 | 29.5 | |
| | member | | | | | |
| S2 | | Infinity | 2.500 | 1.717 | 29.5 | |
| S3 | | Infinity | 2.000 | | | |
| S4 | First lens | 3.356 | 1.790 | 1.535 | 56 | 5.322 |
| S5 | | −15.746 | 0.125 | | | |
| S6 | Second lens | 78.094 | 0.951 | 1.615 | 25.9 | −4.114 |
| S7 | | 2.461 | 0.609 | | | |
| S8 | Third lens | 894.88000 | 0.951 | 1.671 | 19.2 | 25.344 |
| S9 | | −17.53559 | 0.168 | | | |
| S10 | Fourth lens | 2.90836 | 0.742 | 1.615 | 25.9 | 29.008 |
| S11 | | 3.13005 | 6.262 | | | |
| S12 | Filter | Infinity | 0.336 | 1.516 | 64.1 | |
| S13 | | Infinity | 0.844 | | | |
| S14 | Imaging | Infinity | | | | |
| | plane | | | | | |

The total focal length f of the optical imaging system in the fourth example may be 13.2 mm, Fno may be 3.7, a half the diagonal length of the imaging plane 470 may be 2.48 mm, and a combined focal length of the second lens 420 to the fourth lens 440 may be −6.109 mm.

In the fourth example, the first lens 410 may have positive refractive power, and first and second surfaces of the first lens 410 may be convex.

The second lens 420 may have negative refractive power, and the first surface of the second lens 420 may be convex, and the second surface of the second lens 420 may be concave.

The third lens 430 may have positive refractive power, and first and second surfaces of the first lens 410 may be convex.

The fourth lens 440 may have positive refractive power, the first surface of the fourth lens 440 may be convex, and the second surface of the fourth lens 440 may be concave.

The optical imaging system in the fourth example may be configured such that the image sensor IS may move for focus adjustment. For example, the image sensor IS of the optical imaging system in the fourth example may move in the optical axis direction.

Table 14 lists a moving distance AFS of the image sensor IS in the optical axis direction according to the object distance OD in the optical imaging system in the fourth example.

TABLE 14

| Object | Moving distance of imaging sensor in |
|---|---|
| distance | optical axis direction |
| 2.0M | 0.0876 mm |
| 1.5M | 0.1171 mm |
| 1.0M | 0.1763 mm |
| 0.5M | 0.3572 mm |

The optical imaging system in the fourth example may satisfy the conditional expression as below:

Conditional Expression 15: 0.15 mm<AFS_1.0<0.25 mm

In the conditional expression, AFS_1.0 is a moving distance of the image sensor IS in the optical axis direction with respect to an object distance OD of 1.0 meter.

The optical imaging system in the fourth example may be configured such that the image sensor IS may move for optical image stabilization. For example, the image sensor IS of the optical imaging system in the fourth example may move in a direction perpendicular to the optical axis.

Table 15 lists the moving distance of the image sensor IS in the direction perpendicular to the optical axis according to the amount of shaking in the optical imaging system in the fourth example. The amount of shaking may be measured by a shaking detection unit (e.g., a gyro sensor).

TABLE 15

| Amount of | Moving distance of imaging sensor in direction |
|---|---|
| shaking | perpendicular to optical axis |
| 0.5 deg | 0.113 mm |
| 1.0 deg | 0.226 mm |
| 1.5 deg | 0.340 mm |
| 2.0 deg | 0.453 mm |

The optical imaging system in the fourth example may satisfy the conditional expression as below:

Conditional Expression 17: 0.15 mm<OISC_1.0<0.25 mm

In the conditional expression, OISC_1.0 is a moving distance of the image sensor IS in the direction perpendicular to the optical axis with respect to the amount of shaking of 1.0°.

Since the optical imaging system in the fourth example may perform focus adjustment and optical image stabilization by moving the image sensor IS, power consumption may be reduced.

Each surface of the first lens 410 to the fourth lens 440 may have an aspherical coefficient as provided in Table 16. For example, the object-side surfaces and the image-side surfaces of the first lens 410 to the fourth lens 440 may be aspherical.

TABLE 16

| | S4 | S5 | S6 | S7 |
|---|---|---|---|---|
| conic | −0.25205408 | 32.33789095 | 99 | 0.431592462 |
| constant(K) | | | | |
| 4th | −3.804E−04 | −3.110E−03 | −1.254E−02 | −1.936E−02 |
| coefficient | | | | |
| (A) | | | | |
| 6th | 7.648E−04 | 8.608E−03 | 1.314E−02 | 1.665E−02 |
| coefficient | | | | |
| (B) | | | | |
| 8th | −1.298E−03 | −6.190E−03 | −6.053E−03 | −8.434E−03 |
| coefficient | | | | |
| (C) | | | | |
| 10th | 1.130E−03 | 1.973E−03 | −6.441E−04 | 4.942E−03 |
| coefficient | | | | |
| (D) | | | | |
| 12th | −6.248E−04 | −2.323E−04 | 2.424E−03 | 1.717E−03 |
| coefficient | | | | |
| (E) | | | | |
| 14th | 2.135E−04 | 0.000E+00 | −1.300E−03 | −1.522E−03 |
| coefficient | | | | |
| (F) | | | | |
| 16th | −4.505E−05 | 0.000E+00 | 3.343E−04 | −9.735E−04 |
| coefficient | | | | |
| (G) | | | | |
| 18th | 5.514E−06 | 0.000E+00 | −4.310E−05 | 4.406E−04 |
| coefficient | | | | |
| (H) | | | | |
| 20th | −3.032E−07 | 0.000E+00 | 2.095E−06 | 0.000E+00 |
| coefficient | | | | |
| (J) | | | | |
| | S8 | S9 | S10 | S11 |
| conic | 99 | 40.92235276 | 0.287993248 | 1.622687571 |
| constant(K) | | | | |
| 4th | 4.265E−03 | 2.070E−02 | 1.463E−02 | −4.169E−03 |
| coefficient | | | | |
| (A) | | | | |
| 6th | 3.253E−03 | −2.065E−02 | −2.192E−02 | −5.907E−04 |
| coefficient | | | | |
| (B) | | | | |
| 8th | 2.853E−03 | 1.841E−02 | 1.653E−02 | −4.705E−03 |
| coefficient | | | | |
| (C) | | | | |
| 10th | 2.408E−03 | −4.592E−03 | −7.013E−03 | 3.651E−03 |
| coefficient | | | | |
| (D) | | | | |
| 12th | −2.308E−03 | −2.528E−03 | 1.020E−03 | −1.059E−03 |
| coefficient | | | | |
| (E) | | | | |
| 14th | 0.000E+00 | 1.045E−03 | 0.000E+00 | 0.000E+00 |
| coefficient | | | | |
| (F) | | | | |
| 16th | 0.000E+00 | −6.991E−05 | 0.000E+00 | 0.000E+00 |
| coefficient | | | | |
| (G) | | | | |
| 18th | 0.000E+00 | 0.000E+00 | 0.000E+00 | 0.000E+00 |
| coefficient | | | | |
| (H) | | | | |
| 20th | 0.000E+00 | 0.000E+00 | 0.000E+00 | 0.000E+00 |
| coefficient | | | | |
| (J) | | | | |

Also, the optical imaging system configured as above may have the aberration properties as in FIG. 8.

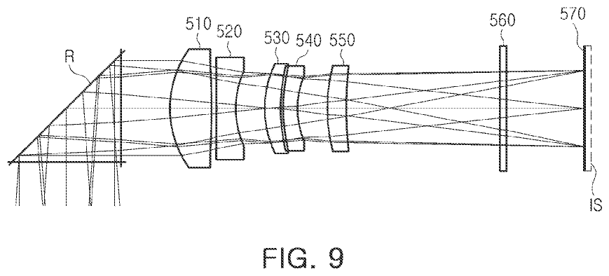

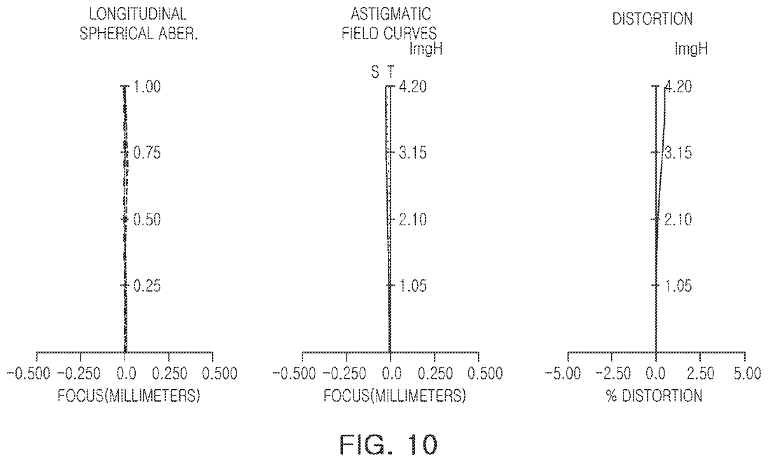

An optical imaging system according to a fifth example will be described with reference to FIGS. 9 and 10.

The optical imaging system in the fifth example may include an optical system including a first lens 510, a second lens 520, a third lens 530, a fourth lens 540, and a fifth lens 550 and may further include a filter 560 and an image sensor IS.

Also, the optical imaging system may further include a reflective member R disposed in front of the first lens 510 and having a reflective surface for changing a path of light. In the fifth embodiment, the reflective member R may be implemented as a prism, but may also be implemented as a mirror.

The optical imaging system in the fifth example may form a focus on the imaging surface 570. The imaging surface 570 may refer to a surface on which a focus is formed by the optical imaging system. For example, the imaging surface 570 may refer to one surface of the image sensor IS on which light is received.

Lens properties of each lens (a radius of curvature, a thickness of the lens or a distance between lenses, a refractive index, an Abbe number, and a focal length) may be as provided in Table 17.

TABLE 17

| Surface | | Radius of | Thickness | Refractive | Abbe | Focal |
|---|---|---|---|---|---|---|
| No. | Note | curvature | or distance | index | number | length |
| S1 | Reflective | Infinity | 2.500 | 1.717 | 29.5 | |
| | member | | | | | |
| S2 | | Infinity | 2.500 | 1.717 | 29.5 | |
| S3 | | Infinity | 2.000 | | | |
| S4 | First lens | 5.189 | 2.200 | 1.535 | 56 | 8.214 |
| S5 | | −24.946 | 0.248 | | | |
| S6 | Second lens | −333.325 | 1.000 | 1.615 | 25.9 | −6.523 |
| S7 | | 4.103 | 1.506 | | | |
| S8 | Third lens | 5.07583 | 1.000 | 1.671 | 19.2 | 13.320 |
| S9 | | 10.64859 | 0.162 | | | |
| S10 | Fourth lens | 7.74817 | 0.867 | 1.615 | 25.9 | −13.630 |
| S11 | | 3.87074 | 1.563 | | | |
| S12 | Fifth lens | 6.69216 | 1.000 | 1.535 | 56 | 22.345 |
| S13 | | 14.02434 | 7.981 | | | |
| S14 | Filter | Infinity | 0.300 | 1.516 | 64.1 | |
| S15 | | Infinity | 3.454 | | | |
| S16 | Imaging | Infinity | | | | |
| | plane | | | | | |

The total focal length f of the optical imaging system in the fifth example may be 22 mm, Fno may be 3.8, a half the diagonal length of the imaging plane 570 may be 4.2 mm, and a combined focal length of the second lens 520 to the fifth lens 550 may be −9.85 mm.

In the fifth example, the first lens 510 may have positive refractive power, and first and second surfaces of the first lens 510 may be convex.

The second lens 520 may have negative refractive power, and first and second surfaces of the second lens 520 may be concave.

The third lens 530 may have positive refractive power, and the first surface of the third lens 530 may be convex, and the second surface of the third lens 530 may be concave.

The fourth lens 540 may have negative refractive power, the first surface of the fourth lens 540 may be convex, and the second surface of the fourth lens 540 may be concave.

The fifth lens 550 may have positive refractive power, the first surface of the fifth lens 550 may be convex, and the second surface of the fifth lens 550 may be concave.

The optical imaging system in the fifth example may be configured such that the image sensor IS may move for focus adjustment. For example, the image sensor IS of the optical imaging system in the fifth example may move in the optical axis direction.

Table 18 lists a moving distance AFS of the image sensor IS in the optical axis direction according to the object distance OD in the optical imaging system in the fifth example.

TABLE 18

| Object | Moving distance of imaging sensor in |
|---|---|
| distance | optical axis direction |
| 2.0M | 0.2029 mm |
| 1.5M | 0.3456 mm |
| 1.0M | 0.5126 mm |
| 0.5M | 1.0283 mm |

The optical imaging system in the fifth example may satisfy the conditional expression as below:

Conditional Expression 18: 0.4 mm<AFS_1.0<0.6 mm

In the conditional expression, AFS_1.0 is a moving distance of the image sensor IS in the optical axis direction with respect to an object distance OD of 1.0 meter.

The optical imaging system in the fifth example may be configured such that the image sensor IS may move for optical image stabilization. For example, the image sensor IS of the optical imaging system in the fifth example may move in a direction perpendicular to the optical axis.

Table 19 lists the moving distance of the image sensor IS in the direction perpendicular to the optical axis according to the amount of shaking in the optical imaging system in the fifth example. The amount of shaking may be measured by a shaking detection unit (e.g., a gyro sensor).

TABLE 19

| Amount of | Moving distance of imaging sensor in direction |
|---|---|
| shaking | perpendicular to optical axis |
| 0.5 deg | 0.191 mm |
| 1.0 deg | 0.384 mm |
| 1.5 deg | 0.576 mm |
| 2.0 deg | 0.768 mm |

The optical imaging system in the fifth example may satisfy the conditional expression as below:

Conditional Expression 19: 0.3 mm<OISC_1.0<0.4 mm

In the conditional expression, OISC_1.0 is a moving distance of the image sensor IS in the direction perpendicular to the optical axis with respect to the amount of shaking of 1.0°.

Since the optical imaging system in the fifth example may perform focus adjustment and optical image stabilization by moving the image sensor IS, power consumption may be reduced.

Each surface of the first lens 510 to the fifth lens 550 may have an aspherical coefficient as provided in Table 20. For example, the object-side surfaces and the image-side surfaces of the first lens 510 to the fifth lens 550 may be aspherical.

TABLE 20

| | S4 | S5 | S6 | S7 | S8 |
|---|---|---|---|---|---|
| conic | −0.63588104 | −16.6933114 | −99 | 0.042706966 | 0.765523528 |
| constant | | | | | |
| 4th | 3.896E−04 | 1.258E−03 | −1.045E−03 | −3.775E−03 | −1.852E−03 |
| coefficient | | | | | |
| 6th | 1.963E−05 | −6.687E−04 | −8.082E−04 | −4.386E−04 | 9.111E−04 |
| coefficient | | | | | |
| 8th | −7.647E−06 | 3.543E−04 | 5.863E−04 | 2.777E−04 | −9.617E−04 |
| coefficient | | | | | |
| 10th | 3.335E−06 | −1.063E−04 | −1.917E−04 | −4.573E−05 | 5.469E−04 |
| coefficient | | | | | |
| (D) | | | | | |
| 12th | −7.910E−07 | 2.001E−05 | 3.873E−05 | −7.721E−06 | −1.667E−04 |
| coefficient | | | | | |
| (E) | | | | | |
| 14th | 1.108E−07 | −2.377E−06 | −4.952E−06 | 4.833E−06 | 2.620E−05 |
| coefficient | | | | | |
| (F) | | | | | |
| 16th | −9.087E−09 | 1.714E−07 | 3.866E−07 | −8.920E−07 | −1.665E−06 |
| coefficient | | | | | |
| (G) | | | | | |
| 18th | 3.973E−10 | −6.826E−09 | −1.675E−08 | 7.581E−08 | −3.191E−08 |
| coefficient | | | | | |
| (H) | | | | | |
| 20th | −7.152E−12 | 1.149E−10 | 3.080E−10 | −2.513E−09 | 6.183E−09 |
| coefficient | | | | | |
| (J) | | | | | |
| | S9 | S10 | S11 | S12 | S13 |
| conic | 4.170484928 | −2.39760089 | 0.082090575 | 5.359714379 | 24.17237688 |
| constant | | | | | |
| 4th | −4.327E−03 | −5.626E−03 | −5.280E−03 | −6.300E−03 | −3.964E−03 |
| coefficient | | | | | |
| 6th | 7.426E−03 | 7.960E−03 | 1.669E−03 | −4.794E−04 | −2.560E−04 |
| coefficient | | | | | |
| 8th | −9.056E−03 | −1.068E−02 | −3.363E−03 | 2.425E−04 | 2.881E−05 |
| coefficient | | | | | |
| 10th | 6.129E−03 | 7.556E−03 | 3.004E−03 | −3.599E−04 | −1.276E−04 |
| coefficient | | | | | |
| (D) | | | | | |
| 12th | −2.378E−03 | −3.046E−03 | −1.451E−03 | 2.958E−04 | 1.428E−04 |
| coefficient | | | | | |
| (E) | | | | | |
| 14th | 5.377E−04 | 7.207E−04 | 4.148E−04 | −1.275E−04 | −6.832E−05 |
| coefficient | | | | | |
| (F) | | | | | |
| 16th | −6.904E−05 | −9.805E−05 | −6.956E−05 | 3.020E−05 | 1.695E−05 |
| coefficient | | | | | |
| (G) | | | | | |
| 18th | 4.557E−06 | 6.992E−06 | 6.290E−06 | −3.744E−06 | −2.145E−06 |
| coefficient | | | | | |
| (H) | | | | | |
| 20th | −1.149E−07 | −1.977E−07 | −2.357E−07 | 1.899E−07 | 1.096E−07 |
| coefficient | | | | | |
| (J) | | | | | |

Also, the optical imaging system configured as above may have the aberration properties as in FIG. 10.

According to the aforementioned examples, the optical imaging system may be mounted on a portable electronic device having a thin thickness and may be driven with low power.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a lens unit comprising at least three lenses;
an image sensor configured to move along an optical axis direction and to receive light that has passed through the lens unit; and
a reflective member disposed on an object side of the lens unit and comprising a reflective surface configured to change a path of light,
wherein 0<(SAS/f)/OD<0.15, where SAS is a moving distance of the image sensor along the optical axis direction, f is a total focal length of the lens unit, and OD is an object distance.

2. The optical imaging system of claim 1,
wherein the lens unit comprises a first lens, a second lens and a third lens disposed in order from the object side, and
wherein 0.6 mm<AFS_1.0<0.8 mm, where AFS_1.0 is a moving distance of the image sensor along the optical axis direction with respect to an object distance of 1 meter.

3. The optical imaging system of claim 2,
wherein the image sensor is configured to move in a direction perpendicular to the optical axis direction, and
wherein 0.4 mm<OISC_1.0<0.5 mm, where OISC_1.0 is a moving distance of the image sensor in the direction perpendicular to the optical axis direction with respect to an amount of shaking of 1.0°.

4. The optical imaging system of claim 2, wherein the first lens has positive refractive power, the second lens has negative refractive power, and the third lens has positive refractive power.

5. The optical imaging system of claim 4, wherein each of the first lens, the second lens, and the third lens comprises a convex object-side surface and a concave image-side surface.

6. The optical imaging system of claim 1,
wherein the lens unit comprises a first lens, a second lens, a third lens, and a fourth lens disposed in order from the object side, and
wherein 0.15 mm<AFS_1.0<0.25 mm, where AFS_1.0 is a moving distance of the image sensor along the optical axis direction with respect to an object distance of 1 meter.

7. The optical imaging system of claim 6,
wherein the image sensor is configured to move in a direction perpendicular to the optical axis direction, and
wherein 0.2 mm<OISC_1.0<0.3 mm, where OISC_1.0 is a moving distance of the image sensor in the direction perpendicular to the optical axis direction with respect to an amount of shaking of 1.0°.

8. The optical imaging system of claim 6,
wherein the image sensor is configured to move in a direction perpendicular to the optical axis direction, and
wherein 0.15 mm<OISC_1.0<0.25 mm, where OISC_1.0 is a moving distance of the image sensor in the direction perpendicular to the optical axis direction with respect to an amount of shaking of 1.0°.

9. The optical imaging system of claim 6, wherein the first lens has positive refractive power, the second lens has negative refractive power, the third lens has positive refractive power, and the fourth lens has positive refractive power.

10. The optical imaging system of claim 9, wherein the first lens comprises a convex object-side surface and a convex image-side surface, and the fourth lens comprises a convex object-side surface and a concave image-side surface.

11. The optical imaging system of claim 10, wherein the second lens comprises a concave object-side surface and a concave image-side surface, and the third lens comprises a convex object-side surface and a concave image-side surface.

12. The optical imaging system of claim 10, wherein the second lens comprises a convex object-side surface and a concave image-side surface, and the third lens comprises a convex object-side surface and a convex image-side surface.

13. The optical imaging system of claim 1,
wherein the lens unit comprises a first lens, a second lens, a third lens, a fourth lens, and a fifth lens disposed in order from the object side, and
wherein 0.4 mm<AFS_1.0<0.6 mm, where AFS_1.0 is a moving distance of the image sensor in the optical axis direction with respect to an object distance of 1 meter.

14. The optical imaging system of claim 13,
wherein the image sensor is configured to move in a direction perpendicular to the optical axis direction, and
wherein 0.3 mm<OISC_1.0<0.4 mm, where OISC_1.0 is a moving distance of the image sensor in the direction perpendicular to the optical axis direction with respect to an amount of shaking of 1.0°.

15. The optical imaging system of claim 13, wherein the first lens has positive refractive power, the second lens has negative refractive power, the third lens has positive refractive power, the fourth lens has negative refractive power, and the fifth lens has positive refractive power.

16. The optical imaging system of claim 15, wherein the first lens comprises a convex object-side surface and a convex image-side surface, the second lens comprises a concave object-side surface and a concave image-side surface, and each of the third, fourth, and fifth lenses comprise a convex object-side surface and a concave image-side surface.

17. The optical imaging system of claim 1, wherein 0.4<f1/|f_rest|<1, where f1 is a focal length of a lens disposed most adjacent to the object side, and f_rest is a combined focal length of the lenses in the lens unit other than the lens disposed most adjacent to the object side.

18. An optical imaging system, comprising:
a lens unit comprising at least three lenses and no more than five lenses; and
an image sensor disposed on an image side of the lens unit and configured to move along an optical axis direction and in a direction perpendicular to the optical axis direction,
wherein 0<(SAS/f)/OD<0.15, where SAS is a moving distance of the image sensor along the optical axis direction, f is a total focal length of the lens unit, and OD is an object distance, and
wherein 0.15 mm<OISC_1.0<0.5 mm, where OISC_1.0 is a moving distance of the image sensor in the direction perpendicular to the optical axis direction with respect to an amount of shaking of 1.0°.

19. The optical imaging system of claim 18, further comprising a reflective member disposed on an object side of the lens unit.

20. The optical imaging system of claim 18, wherein 0.8<TTL/f<1, where TTL is an optical-axis distance from an object-side surface of a lens disposed closest to an object side of the lens unit to an imaging plane.
